(19) United States
(12) Patent Application Publication
(10) Pub. No.: US 2026/0034666 A1
(43) Pub. Date: Feb. 5, 2026

(54) Method for operating a handling system, computer program product, and handling system

(71) Applicant: J.Schmalz GmbH, Glatten (DE)

(72) Inventors: Bernd Heinzmann, Loßburg (DE); Benjamin Guthier, Mannheim (DE); Matthias Frey, Sulz-Dürrenmettstetten (DE); Steffen Krieg, Waldenbuch (DE)

(21) Appl. No.: 19/289,212

(22) Filed: Aug. 4, 2025

(30) Foreign Application Priority Data
Aug. 2, 2024 (DE) 10 2024 122 141.0

(51) Int. Cl. B25J 9/16; B25J 15/06; G06T 7/11; G06T 7/62; G06T 7/70; G06V 20/50

(52) U.S. Cl. CPC B25J 9/1612; B25J 15/0616; G06T 7/11; G06T 7/62; G06T 7/70; G06V 20/50; G06T 2207/30164; G06V 2201/06

(57) ABSTRACT

A method is provided for operating a handling system to transport f gripping objects from a pick-up area to a deposit area, comprising a vacuum gripper having a plurality ofindividually activatable suction points, a manipulator for moving the vacuum gripper, and a control device for controlling the handling system, The method comprises: receiving or determining a gripping object data set representing the position in the pick-up area, weight, and geometry for each gripping object, determining, as a function of the gripping object data set, a gripping strategy data set uniquely assigning at least one suction point to each gripping object, generating gripping control signals based on the gripping strategy data set, causing the handling system to suction the gripping objects with the respectively assigned at least one suction point, and generating manipulator control signals, causing the manipulator to move the vacuum gripper with gripped objects to the deposit area.

The invention relates to a method for operating a handling system, comprising a vacuum gripper and a manipulator for moving the vacuum gripper. The invention also relates to such a handling system.

Handling systems with vacuum grippers are known in a variety of ways from the state of the art. Different types of vacuum grippers are used. For example, so-called area vacuum grippers are known, which have a plurality of suction points. Such area vacuum grippers are used, among other things, to handle stacked, rigid and/or flexible workpieces. An advantageous further development of such area vacuum grippers provides that the individual suction points can be activated independently of one another, so that more or fewer suction points can be used to suction an object as required.

A typical application situation for such handling systems is the transport of workpieces between two processing stations in a production environment. In this case, workpieces are usually gripped individually and transported one after the other to a destination.

The invention addresses the task of improving the transport of gripping objects from a deposit area to a pick-up area using a handling system.

This object is achieved according to the invention by a method having the features of claim 1. The method is a method, in particular a computer-implemented method, for operating, in particular controlling, a handling system. The method is designed to cause the handling system to transport a plurality of gripping objects together from a pick-up area in which the gripping objects are arranged, in particular next to one another, to a deposit area. In this respect, the method is also a method for transporting a plurality of gripping objects from a pick-up area, in which the gripping objects are arranged, in particular next to one another or one above the other, to a deposit area.

The handling system comprises a vacuum gripper for suctioning the gripping objects. The vacuum gripper has, in particular on one suction side, a plurality of suction points that can be activated and deactivated individually, i.e. independently of one another.

The handling system also comprises a manipulator, in particular a robot, for moving the vacuum gripper. The vacuum gripper can be coupled to the manipulator via a coupling device.

In particular, the handling system also has a control device for controlling the handling system. In particular, the control device has a non-volatile memory device. In particular, the control device has a data processing system.

According to the method, a gripping object data set is first received or determined and, in particular, stored on a non-volatile memory device. In this respect, in particular a gripping object data set is provided on a non-volatile memory device, for example the non-volatile memory device of the control device of the handling system. Determining the gripping object data set may comprise receiving gripping object information via a human-machine interface of the handling system. Determining the gripping object data set may also comprise analyzing image data of the gripping objects.

In particular, the gripping object data set comprises position data for each gripping object, which represents a position of the gripping object in the pick-up area. In particular, the gripping object data set also comprises weight data representing the weight of the gripping object. In particular, the gripping object data set also comprises geometry data representing a geometry of the respective gripping object.

According to the method, a gripping strategy data set is then determined as a function of the gripping object data set, on the basis of which the gripping objects are to be gripped by means of the vacuum gripper. In particular, the gripping strategy data set represents which suction points of the vacuum gripper are to be used to grip which gripping object and, in particular, in which order.

The gripping strategy data set comprises assignment data that uniquely assigns at least one suction point of the plurality of suction points of the vacuum gripper to each gripping object. In this respect, it is determined with which suction point or suction points a respective gripping object is to be gripped.

According to the method, gripping control signals are then generated on the basis of the gripping strategy data set, which cause the handling system to suction gripping objects one after the other with the at least one suction point respectively assigned until the gripping objects are held together on the vacuum gripper. In this respect, the gripping objects are suctioned one after the other with the at least one suction point assigned to them until the gripping objects are held together on the vacuum gripper. The gripping control signals comprise, in particular, control instructions for the manipulator and control instructions for the vacuum gripper.

In a further step, manipulator control signals are then generated which cause the handling system, in particular the manipulator, to move the vacuum gripper with the plurality of objects suctioned onto it from the pick-up area to a deposit area.

In particular, the method also comprises generating control signals which cause the handling system, in particular the vacuum gripper, to deposit the objects at the deposit arca. It is conceivable that all suctioned gripping objects are deposited at the same time. In this respect, the control signals can cause the vacuum gripper to deactivate the initially activated suction points together, in particular simultaneously. The gripping objects can also be deposited sequentially, i.c. one after the other. In this way, the control signals can cause the vacuum gripper to deactivate only those suction points assigned to a particular gripping object at a given time.

The proposed method enables the automated transport of multiple objects, even of different sizes and shapes, between two locations in a particularly time-and energy-efficient manner. Because the gripping objects are not all suctioned at the same time, but one after the other, it is possible to change the arrangement of the gripping objects on the vacuum gripper compared to their arrangement in the pick-up area. This makes it possible to arrange the gripping objects in particularly advantageous configurations on the vacuum gripper, for example in such a way that as many gripping objects as possible can be transported at once or, for example, that a specified minimum distance is maintained between certain gripping objects.

In this context, the term “gripping object” refers to an object that is actually intended to be gripped by the vacuum gripper. This does not exclude the possibility that there are other objects in the pick-up area which are not intended to be gripped (e.g. carriers for the gripping objects, dirt, process residues, etc.) and therefore do not constitute “gripping objects”.

The proposed method is suitable for gripping objects of different properties, in particular different shapes and sizes. In particular, the method is suitable for handling flat materials, preferably sheet metal.

In the present context, the term “geometry” does not necessarily mean a detailed description of the entire external shape of the gripping object. Preferably, however, the “geometry” describes at least an outline (or silhouette and outer contour) of the gripping object when viewed from above. In particular, “geometry” or the geometry data can also include information on edges of the gripping object and/or local recesses in the gripping object, in particular in an area delimited by the outline.

In the present context, a “data set” may comprise one or more sub-data sets.

In the present context, the term “activating” a suction point means transferring the suction point into an active configuration in which the suction point is ready to suction an object. In particular, activating comprises releasing a supply of vacuum to the suction point. Activating can comprise the translational and/or rotational movement of the suction point (individually or as part of a suction point group). Moving the suction point may result in the vacuum supply being released. However, it is also conceivable that the moving is independent of the release of the vacuum supply. For example, the suction points can be permanently supplied with vacuum, but the suction points can only be transferred into an active configuration by translational and/or rotational movement, in which the suction point is ready to suction an object (i.e. is activated).

In the present context, the term “deactivating” a suction point means the transferring the suction point (from the active configuration) into a passive configuration in which the suction point is no (longer) ready to suction an object. In particular, deactivating comprises interrupting the supply of vacuum to the suction point. Deactivating may comprise translational and/or rotational movement of the suction point (individually or as part of a suction point group). Moving may result in an interruption of the vacuum supply. However, it is also conceivable that moving is independent of an interruption of the vacuum supply.

The vacuum gripper may be designed in different ways. In an advantageous implementation, the vacuum gripper comprises a gripper base body and a plurality of suction units arranged thereon, each of which provides a suction point. In particular, the suction units each have a lifting piston and at least one suction cup that is motion-coupled to the lifting piston. The lifting piston is preferably adjustable along a lifting axis relative to the gripper base body between an axially retracted passive configuration and an axially extended active configuration. The suction units are preferably designed in such a way that a vacuum supply to the suction cup is interrupted in the passive configuration and released in the active configuration. For example, the vacuum gripper can have a vacuum connection for connection to an external vacuum supply, wherein a shut-off device is provided which, in the passive configuration of the lifting piston, shuts off a flow connection between the vacuum connection and the at least one suction cup and releases this flow connection in the active configuration. Such an embodiment with extendable suction units is particularly advantageous, as the non-activated suction points do not form any interference contours when gripping due to their retracted configuration.

The manipulator can be designed in different ways. In an advantageous implementation, the manipulator can be designed as a robot, in particular a 6-axis robot.

The pick-up area can, for example, be an output area of a processing machine. The deposit area can, for example, be a storage location or an infeed area of another processing machine.

Preferably, determining the gripping strategy data set, in particular the assignment data, for each gripping object comprises determining a minimum number n_{req} of suction points required for gripping the gripping object. The number n_{req} of suction points is determined as a function of the weight of the gripping object. In particular, the number n_{req} is determined as the number of suction points at which the cumulative suction force of the suction points n_{req} is greater than the weight of the gripping object.

According to an advantageous further development of the method, the number n_{req} of required suction points can also be determined under one or more further boundary conditions. In particular, the number n_{req} of required suction points can be determined as a function of expected acceleration forces when handling the gripping objects. For example, the number n_{req} can be determined as the number of suction points at which the cumulative suction force of the suction points n_{req} is greater than the sum of the weight of the gripping object and the expected acceleration forces.

Alternatively or additionally, the number n_{req} of required suction points can be determined as a function of a material of the gripping object. For example, a porosity of the material of the gripping object can be taken into account as a boundary condition when determining the number of n_{req}, in particular in such a way that a higher porosity requires a higher number of suction points. In this context, it is conceivable, for example, that the method comprises receiving material information via a human-machine interface of the handling system. It is also conceivable that the method comprises determining the gripping object material, for example by analyzing image data of the gripping objects.

Determining the gripping strategy data set, in particular the assignment data, preferably also comprises selecting an at least n_{req} corresponding number nₒᵤₜ of suction points from the plurality of suction points. The suction points are selected depending on the geometry data of the gripping object to be gripped and the geometry data of at least a subset of the other gripping objects, in particular all other gripping objects.

As mentioned above, the proposed method allows the gripping objects to be held on the vacuum gripper in advantageous configurations. In a particularly advantageous further development, selecting the suction points (or assigning the suction points to the individual gripping objects) can, for example, be carried out in such a way that the gripping objects are held on the vacuum gripper in a torque-balanced manner after suctioning or gripping. In this respect, selecting the suction points can be carried out under the boundary condition that the gripping objects are held on the vacuum gripper in a torque-balanced manner after gripping. In the present context, “torque-balanced” means in particular that, when the gripping objects are suctioned onto the vacuum gripper, no rotational or tilting torque is exerted about an axis running parallel to the suction side as a result of the weight of the gripping objects, or such a rotational or tilting torque does not exceed a specified threshold value.

Alternatively or additionally, the suction points can be selected in such a way that at least a subset of the gripping objects, in particular all gripping objects, are held on the vacuum gripper after suctioning or gripping without overlapping, i.e. do not overlap. In this respect, the suction points can be selected in such a way that the gripping objects are held next to one another on the vacuum gripper after suctioning.

Selecting the suction points can also be carried out in such a way that at least a subset of the gripping objects, in particular all gripping objects, are held on the gripper at a predetermined safety distance after suctioning. This can be advantageous, for example, if interaction between the gripping objects is to be avoided.

Selecting the suction points can also be carried out in such a way that at least a subset of the gripping objects are held overlapping on the vacuum gripper after suctioning, i.c. at least a subset of the gripping objects cover one another. This can be advantageous, for example, if a high gripping performance (high packing density on the vacuum gripper) is desired.

Furthermore, it proves to be advantageous if selecting the suction points is determined as a function of a position of the gripping objects relative to one another in the pick-up area. For example, determining the selection of suction points can be carried out under the boundary condition that gripping objects that are next to one another in the pick-up area are preferably assigned to suction points that are next to one another on the vacuum gripper. In this way, the suction process can be designed to be particularly time-and energy-efficient, as, in particular between suctioning two adjacent gripping objects, no or only a slight movement of the manipulator is required.

Furthermore, it proves to be advantageous if determining the gripping strategy data set, in particular selecting the suction points, comprises determining a position and/or orientation of the suction points on the gripping object. Determining the position and/or orientation is preferably carried out as a function of the geometry of the gripping object and, in particular, the geometry of at least a subset of the other gripping objects. Preferably, the gripping control signals are then determined in such a way that the suction points are placed on the gripping object in the determined position and/or orientation. The gripping control signals are preferably designed such that they cause the manipulator to move the vacuum gripper to a respective gripping object in such a way that the at least one suction point assigned to this gripping object contacts the gripping object at the determined position and in the determined orientation relative to the gripping object.

In an advantageous further development, the gripping strategy data set can also describe a gripping sequence in which the gripping objects are to be suctioned. The gripping of the gripping objects, i.e. the suctioning with the respectively assigned at least one suction point, then takes place in particular according to the gripping sequence. In this respect, determining the gripping strategy data set may also comprise determining a gripping sequence.

Preferably, the gripping sequence is determined as a function of a respective height position of the gripping objects in the pick-up area. It is conceivable that a gripping sequence is determined in such a way that higher gripping objects are gripped carlier. In this way, the risk of collisions during the suctioning of the gripping objects can be reduced. It is also conceivable that a gripping sequence is determined in such a way that lower gripping objects are gripped carlier.

In the present context, “height position” means a position of a suction surface of the gripping objects along the vertical (z-axis). The term “suction surface” refers to the outer surface to which the gripping object is to be suctioned. A different height position can, for example, result from a different thickness of the gripping objects. In this respect, the gripping sequence can be determined depending on the thickness of the gripping objects. For example, the geometry data may comprise information on the thickness of a gripping object. A different height position can also result from an irregular surface of the pick-up area. A different height position can also result from an object stack height.

In an advantageous further development, determining the gripping strategy data set, in particular selecting the suction points, is carried out in such a way that a second gripping object suctioned after a first gripping object (after it has been suctioned) at least partially covers the first gripping object. In this respect, the first and second gripping objects can overlap, at least in sections. In this respect, the second gripping object can form a support object for the first gripping object. This makes it possible, for example, to allow higher manipulator accelerations (which has a positive effect on gripping efficiency) while still ensuring safe gripping. For example, it is conceivable that a plurality of comparatively small gripping objects and at least one comparatively large gripping object are provided in the pick-up area. In such an initial situation, it may then be advantageous for the gripping strategy data set, in particular a gripping sequence, to be determined in such a way that first one or more or all of the small gripping objects are suctioned and then the large gripping object is suctioned in such a way that it covers at least a subset of the suctioned small gripping objects.

It may also be advantageous if a manipulator dynamic, in particular a maximum acceleration of the manipulator, is specified. In particular, the gripping control signals and, in particular, the manipulator control signals define an acceleration of the manipulator after gripping a respective gripping object.

In the embodiment described above, in which a second gripping object suctioned after a first gripping object at least partially covers the first gripping object, it may be particularly advantageous if the control signals, in particular the gripping control signals, are determined in such a way that this acceleration is greater after gripping the second gripping object than after gripping the first gripping object. In this respect, the control signals, in particular the gripping control signals, are determined in particular in such a way that the first gripping object is picked up with lower manipulator dynamics, in particular manipulator acceleration, than the second gripping object.

In an advantageous further development, the handling system may comprise a plurality of different vacuum grippers, in particular with a different number and/or arrangement of the suction points. Then, the gripping strategy data set may also represent the vacuum gripper of the plurality of vacuum grippers preferred for gripping the gripping objects. Determining the preferred vacuum gripper may be carried out in particular depending on the gripping object data set(s). The method may then in particular comprise generating vacuum gripper coupling control signals based on the gripping strategy data set, wherein the vacuum gripper coupling control signals cause the handling system to couple the preferred vacuum gripper to the manipulator. In particular, several different vacuum grippers can be exchanged.

It is also conceivable that one or more gripping object data sets are provided, in particular read in, on the memory device, wherein an evaluation algorithm is stored on the memory device which determines the preferred vacuum gripper or vacuum gripper constellations depending on the gripping object data sets provided. This function can also be used to design a vacuum gripper during the engineering phase. This can reduce the number of grippers required. It is also possible to determine how many gripping objects can be gripped before they are presented to the handling system for manipulation.

The handling system can have one or more operating modes. In an advantageous further development, the handling system can have a high-performance operating mode. The high-performance operating mode can be optimized in particular for high gripping performance (picking performance), in particular an object throughput (gripping objects/hour). This can be realized, for example, by allowing high manipulator acceleration in high-performance operating mode, reducing the number of suction points used per gripping object (enabling more objects to be held on the vacuum gripper at the same time) and/or enabling overlapping or crossing of gripping objects.

In an exemplary implementation, in high-performance operating mode, determining the gripping strategy data set may be carried out in such a way that a gripping object is only assigned the minimum number n_{req} of suction points required for gripping. In particular, only the minimum number n_{req} of suction points required for gripping can be selected. This makes it possible to hold many gripping objects on the vacuum gripper at the same time, which increases picking performance.

Alternatively or additionally, in high-performance operating mode, determining the gripping strategy data set, in particular selecting the suction points, can be carried out in such a way that a second gripping object suctioned after a first gripping object at least partially covers the first gripping object. In this respect, object overlapping/crossing may be permitted, which has a positive effect on packing density and therefore gripping performance. In this context, it may be advantageous if the gripping control signals are determined in such a way that an acceleration of the manipulator after gripping the second gripping object is greater than after gripping the first gripping object.

Preferably, in high-performance operating mode, the gripping objects are handled with comparatively high manipulator accelerations, in particular both during suctioning or picking up, as well as during joint movement from the pick-up location to the deposit location.

Alternatively or additionally, the handling system may have a safety operating mode. In particular, the safety operating mode is optimized to ensure that the gripping objects are gripped securely and that, for example, gripping errors are minimized.

In an exemplary implementation of the safety operating mode, determining the gripping strategy data set, in particular selecting the suction points, can be carried out in such a way, in particular depending on the geometry data set, and in particular the gripping objects are suctioned in such a way that the gripping objects (after all gripping objects have been suctioned) are held next to one another, i.e. without overlapping, on the vacuum gripper. In this way, interactions between the gripping objects can be reduced. For example, a gripping error of a gripping object does not affect another gripping object.

Alternatively or additionally, in safety operating mode, determining the gripping strategy data set, in particular selecting the suction points, may also comprise determining a position and/or orientation of the at least one suction point assigned to a gripping object on this gripping object. The position and/or orientation are preferably determined as a function of the geometry or the geometry data set of a respective gripping object in such a way that edges of the gripping object are arranged between the suction points. In this way, gripping errors can be avoided, for example because a suction point does not seal properly. In this context, “edge” refers to both outer edges and inner edges (e.g. resulting from a recess in the gripping object).

Alternatively or additionally, in safety operating mode, determining the gripping strategy data set can be carried out in such a way that a gripping object is assigned more than the minimum number n_{req} of suction points required for gripping, e.g. 20% more suction points. In this respect, more than the minimum number n_{req} of suction points required for gripping can be selected for each gripping object.

Preferably, in safety operating mode, the gripping objects are handled with comparatively low manipulator accelerations, in particular both during suctioning or picking up, as well as during joint movement from the pick-up location to the deposit location.

In particular, the control signals, in particular the gripping control signals and/or the manipulator control signals, can define a maximum acceleration of the manipulator when handling the suctioned gripping objects. Preferably, this maximum acceleration of the manipulator, in particular a maximum acceleration of the manipulator when moving the gripping objects from the pick-up area to the deposit area, is greater in the high-performance operating mode than in the safety operating mode.

Alternatively or additionally, the handling system may have a suction cup protection operating mode. In particular, the suction cup protection operating mode is optimized to protect the vacuum gripper, in particular the suction points (e.g. suction bodies), as much as possible, and in particular to reduce wear.

In an exemplary implementation of the suction cup protection operating mode, determining the gripping strategy data set, in particular selecting the suction points, may also comprise determining a position and/or orientation of the at least one suction point assigned to a gripping object on this gripping object. The position and/or orientation are preferably determined as a function of the geometry or the geometry data set of a respective gripping object in such a way that edges of the gripping object are arranged between the suction points. In this way, gripping errors can be avoided, for example because a suction point does not seal properly. In this context, “edge” refers to both outer edges and inner edges (e.g. resulting from a recess in the gripping object).

Alternatively or additionally, in suction cup protection operating mode, determining the gripping strategy data set may be carried out in such a way that a gripping object is only assigned the minimum number n_{req} of suction points required for gripping. In this respect, only the minimum number n_{req} of suction points required for gripping can be selected for cach gripping object.

Alternatively or additionally, the handling system may have a gripping object protection mode. In particular, the gripping object protection operating mode can be optimized to ensure that the gripping objects are handled particularly gently during gripping.

In an exemplary implementation of the gripping object protection mode, determining the gripping strategy data set, in particular selecting the suction points, can be carried out in such a way that two adjacent gripping objects are held at a specified safety distance on the gripper or at least do not overlap.

It is conceivable that the handling system has only one of the operating modes described above. It is also conceivable that the handling system has several or preferably all of the operating modes described above. It can then be advantageous if the method comprises selecting one of the operating modes before determining the gripping strategy data set. Selecting the operating mode may comprise receiving operating mode information via a human-machine interface of the handling system. In this respect, an operator can select the operating mode. It is also conceivable that the operating mode is selected automatically, e.g. depending on the geometry data set. For example, it is conceivable that an algorithm, in particular an AI-supported algorithm, is stored on the non-volatile memory device of the control device, which algorithm is trained to select one of the operating modes described above depending on the number, position and geometry of the gripping objects present in the pick-up area.

The various operating modes can be stored in a respective operating mode data set on the non-volatile memory device of the control device. In this respect, selecting one of the operating modes may comprise reading out the corresponding operating mode data set. In particular, the operating mode data set may contain the aforementioned boundary conditions for determining the gripping strategy data set.

Suctioning the gripping objects preferably comprises:
a) activating the at least one suction point assigned to a first gripping object,
b) moving the vacuum gripper towards this gripping object;
c) suctioning this gripping object by means of the activated at least one suction point.
d) repeating steps a) to c) for the other gripping objects until all gripping objects are suctioned onto the vacuum gripper, in particular according to the previously determined gripping sequence.

In this respect, the control signals are generated in such a way that the vacuum gripper and the manipulator are caused to carry out the steps described above.

Activating the suction points (e.g. the extension of the lifting pistons) can be carried out while the vacuum gripper is moving towards the gripping object. In this respect, steps a) and b) can take place in parallel.

After suctioning a first gripping object and before suctioning a further gripping object, the vacuum gripper is moved in particular in space. Preferably, after suctioning a first gripping object and before suctioning a further gripping object, the first gripping object is lifted. In this respect, when moving towards the further gripping object, the first gripping object is also moved.

In an advantageous further development, determining the gripping object data set may comprise analyzing image data representing an image of the gripping objects. Analyzing is preferably carried out using image processing methods (generally known). In particular, the method may comprise receiving image data, storing such image data on a non-volatile memory device and subsequently analyzing such image data, in particular by means of image processing methods.

In particular, the position and geometry of a respective gripping object are determined from the image data by means of image processing methods.

Preferably, the weight of a respective gripping object is also determined from the image data. In particular, determining the weight or weight data of a gripping object may comprise determining a volume of this gripping object (gripping object volume). For this purpose, the image data can be analyzed, for example, by means of workpiece segmentation methods. The weight of the gripping object can then be determined from the gripping object volume via the material of the gripping object, in particular its density. Such an embodiment facilitates operation and increases flexibility, as required user input can be reduced.

It is conceivable that the method comprises receiving gripping object material data, for example via a human-machine interface of the handling system, wherein the gripping object material data contain information about the material of the gripping object, in particular a density of the material.

Preferably, however, the material of the gripping object is also determined automatically. In this respect, determining the weight of a respective gripping object may comprise determining the material of the gripping object. Determining the material of the gripping object can preferably comprise analyzing the image data by means of a machine learning algorithm which is trained to determine a material of the gripping object from image data representing an image of a gripping object. Such an embodiment further facilitates operation.

The weight of the gripping object can then be determined from the determined gripping object volume and the density of the gripping object material. For this purpose, it is conceivable that a database is stored in a non-volatile memory device which comprises information on the density of various materials, in particular for the materials commonly used. It is also conceivable that the machine learning algorithm directly outputs the density of the material.

Receiving the image data may comprise reading in image data. Preferably, however, the handling system also has an acquisition device, in particular a camera, for capturing an image of the gripping objects in the pick-up area. Receiving image data may then comprise generating control signals which cause the acquisition device to capture at least one image of the gripping objects and to store the at least one image in the form of image data in a non-volatile memory device, for example the non-volatile memory device of the control device of the handling system.

The handling system may have a sensor device for monitoring a gripping state. In particular, the sensor device can be configured to detect whether a gripping object to be gripped has actually been gripped or, for example, has not been reliably suctioned due to a gripping error. The sensor device can, for example, comprise a pressure sensor which detects a vacuum in the vacuum gripper. The pressure sensor can be arranged, for example, in the vacuum gripper or in a vacuum generating device of the handling system. Gripping can also be monitored optically. For example, the sensor device may have a camera for monitoring a gripping state.

The method can be carried out several times, for example when there are more objects in the pick-up area than can be transported at once or the objects are continuously provided in the pick-up area (for example as a result of a machining process of workpieces). It is then conceivable that experience gained from the previous cycle or cycles will be drawn upon when the method is carried out again. For example, a position and/or orientation of a suction point can be corrected if suctioning failed in a previous process cycle for a similar gripping object. In an embodiment with a sensor device, for example, the gripping strategy data set of a method cycle can be determined as a function of an output signal of the sensor device in a previous method cycle.

The invention also relates to a computer program product comprising commands which, when the program is executed by the data processing system, in particular by the data processing system of the control device of the handling system, cause the data processing system to execute the method according to one of claims 1 to 12.

The invention also relates to a non-volatile memory medium on which the computer program product is stored.

The invention also relates to a handling system for carrying out the method described above. The handling system comprises a vacuum gripper and a manipulator for moving the vacuum gripper. The vacuum gripper has a plurality of suction points on one suction side, which can be activated and deactivated individually, i.e. independently of one another. The handling system also has a control device for controlling the handling system, in particular the vacuum gripper and/or the manipulator. The control device has a non-volatile memory device and, in particular, a data processing system. Control instructions are stored on the non-volatile memory device which, when executed, cause the handling system to carry out one of the methods described above. In particular, a computer program product is stored on the non-volatile memory device, which comprises commands that, when the program is executed by the data processing system, cause it to perform one of the methods described above.

The vacuum gripper may be designed in different ways. For example, the vacuum gripper can be designed as an area vacuum gripper. In particular, the vacuum gripper has a plurality of suction units, each of which has a movable lifting piston and at least one suction cup that is motion-coupled to the lifting piston. To avoid repetition, reference is made to the above disclosure.

In an advantageous further development, the handling system also comprises an acquisition device, in particular a camera, for capturing an image of the gripping objects in the pick-up area. In particular, the acquisition device can be controlled by the control device. The acquisition device can be arranged in a fixed position, e.g. above the pick-up area. The acquisition device can also be motion-coupled with the manipulator.

The invention is explained in more detail below with reference to the figures. In the drawings:

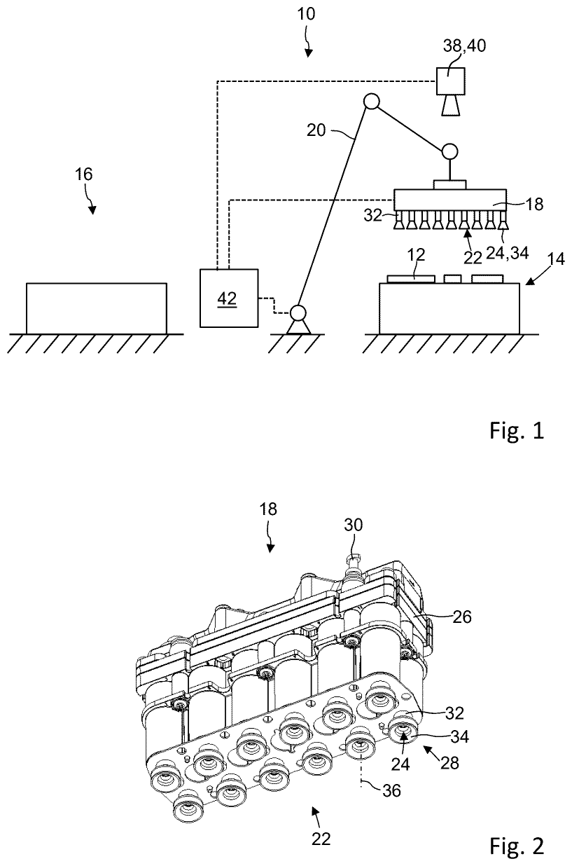

FIG. 1 is a simplified schematic representation of an exemplary embodiment of a handling system;

FIG. 2 is a graphic representation of an exemplary embodiment of a vacuum gripper;

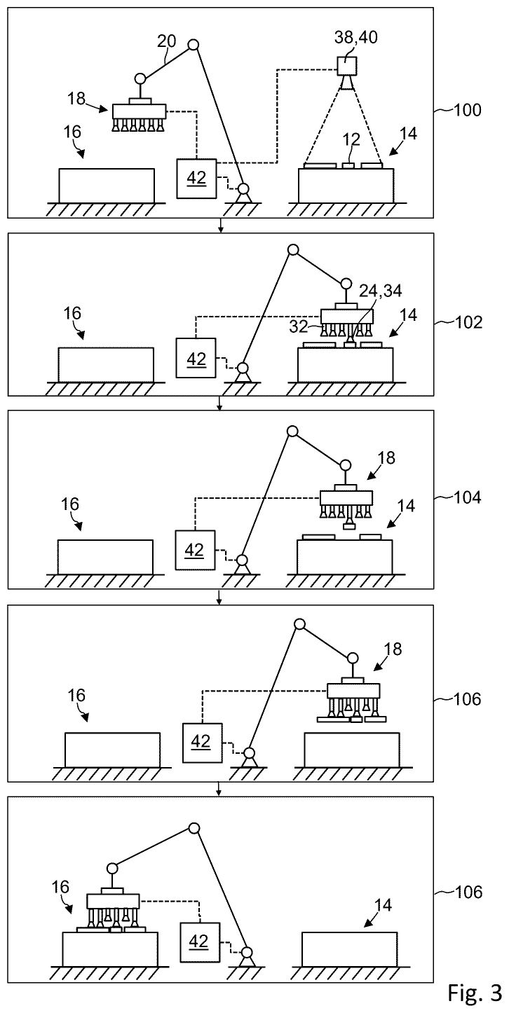

FIG. 3 is a simplified schematic representations to explain an exemplary embodiment of a method for operating the handling system according to FIG. 1;

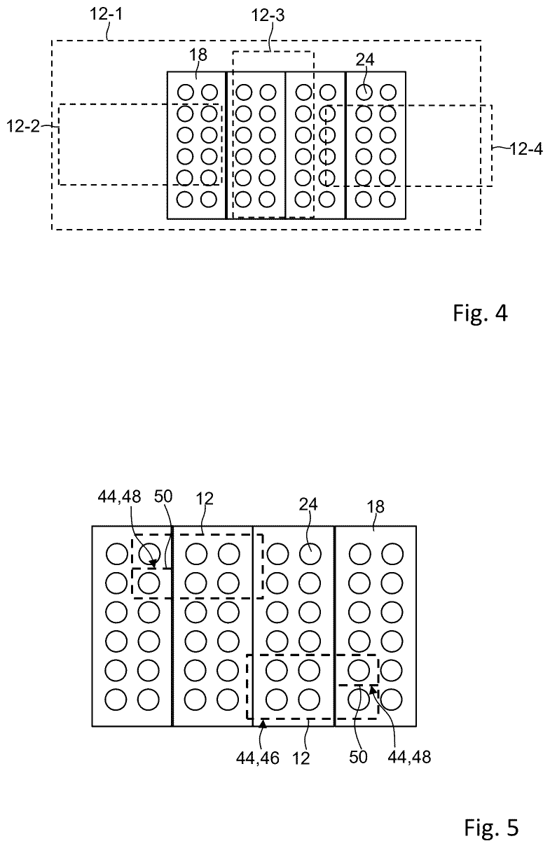

FIG. 4 is a simplified schematic representation to explain an exemplary gripping configuration in a high-performance operating mode of the handling system;

FIG. 5 is a simplified schematic representation to explain an exemplary gripping configuration in a safety operating mode of the handling system;

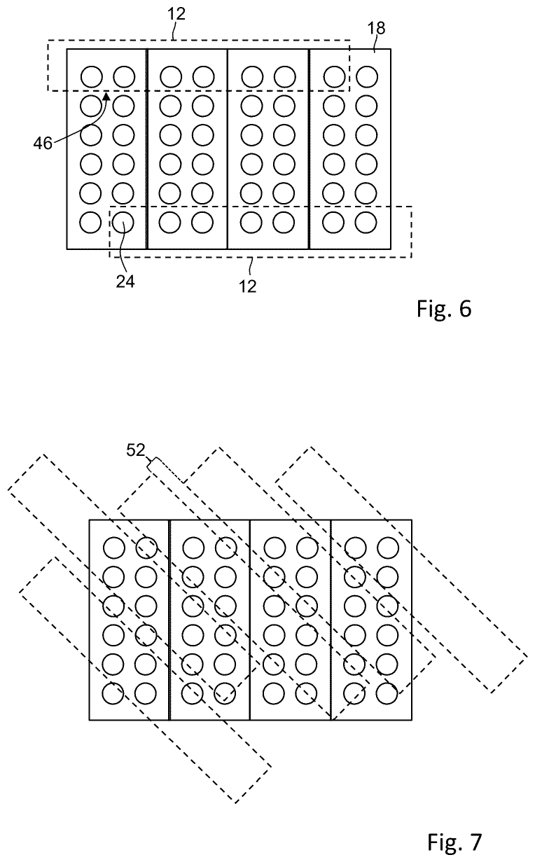

FIG. 6 is a simplified schematic representation to explain an exemplary gripping configuration in a suction cup protection mode of the handling system; and

FIG. 7 is a simplified schematic representation to explain an exemplary gripping configuration in a gripping object protection operating mode of the handling system.

FIG. 1 shows a simplified representation of a handling system, which is designated throughout by reference sign 10. The handling system 10 is designed to transfer gripping objects 12 from a pick-up area 14 to a deposit area 16, for example to transport a workpiece, in particular sheet metal, between two processing stations.

The handling system 10 comprises a vacuum gripper 18 and a manipulator 20 for moving the vacuum gripper 18.

Preferably, the manipulator 20 is designed as a robot, in particular a 6-axis robot.

The vacuum gripper 18 has, on a suction side 22, a plurality of suction points 24 for suctioning a gripping object 12. The suction points 24 are designed to be activated and deactivated independently of one another. In this respect, the suction points 15 can be selectively transferred into an active configuration, in which a suction air flow is provided for suctioning a gripping object 14, and into a passive configuration, in which no suction air flow is provided.

An exemplary implementation is explained below with reference to FIG. 2.

As shown schematically in FIG. 2, the vacuum gripper 18 comprises a gripper base body 26 and a plurality of suction units 28 arranged thereon. The suction units 28 can be supplied with vacuum via a vacuum connection 30 and a vacuum distribution system integrated in the gripper base body 26.

Each suction unit 28 has a lifting piston 32 and a suction cup 34 that is motion-coupled to the lifting piston. The lifting piston 32 is adjustable along a lifting axis 36 between an axially retracted configuration and an axially extended configuration relative to the gripper base body 26.

As mentioned above, the suction units 28 are designed such that, in the passive configuration, a flow connection between the vacuum connection 30 and the suction cup is interrupted and, in the active configuration, this flow connection is released.

In order to transfer the lifting piston 32 from the passive configuration to the active configuration (and thus to activate the suction point 24), the lifting piston 32 can be pressurized with compressed air. In particular, the gripper base body 26 comprises a compressed air connection and an integrated compressed air distribution system for distributing the compressed air to the suction units 28. The compressed air distribution system may in particular comprise a valve device to control the compressed air supply to the individual suction units 28.

The handling system also comprises an optional acquisition device 38, which is designed to capture an image of the gripping objects 12 arranged in the pick-up area 14. In the example, the acquisition device has a camera 40.

As schematically indicated in FIG. 1, the handling system also comprises a control device 42 for controlling the handling system 10. The control device 42 is exemplary for controlling the manipulator 20, the vacuum gripper 18 (in particular the compressed air valve device), as well as the optional acquisition device 38.

In particular, the control device 42 has a non-volatile memory device and a data processing device.

In the following, an exemplary method for operating such a handling system 10 is described with reference to FIG. 3. However, the method is not limited to the embodiment of the handling system 10 shown in FIG. 1.

The method serves to transport the plurality of gripping objects 12 from the pick-up area 14 to the deposit area 16.

In a first step (block 100 in FIG. 3), an image of the gripping objects 12 arranged (next to one another) in the pick-up area is first captured by means of the acquisition device 38 (no longer shown in the further blocks for the sake of clarity). The image is stored in the form of image data on the non-volatile memory device and then analyzed.

In particular, the image data are analyzed by means of methods of image analysis and workpiece segmentation in order to determine the position and location of the gripping objects 12 in the pick-up area 14 as well as a respective outer contour (outline) of the gripping objects 12 (see above).

Preferably, a respective weight of the gripping objects 12 is also determined from the image data. As mentioned above, for this purpose, a respective volume of the gripping objects can be determined from the image data by means of methods of workpiece segmentation. The weight can then be calculated from the volume using the material density of the gripping object. In particular, the material can also be determined from the image data, for example by means of a machine learning algorithm which is trained to determine the material of the gripping object from image data describing an image of a gripping object.

The aforementioned gripping object information (position, geometry, weight) of the gripping objects 12 is then stored on the non-volatile memory device (gripping object data set).

In a further step, a gripping strategy data set is then determined as a function of the gripping object data set, which uniquely assigns a selection of the suction points 24 of the vacuum gripper 18 to each gripping object 12 in such a way that the gripping objects 12 can be gripped next to one another, in particular in a torque-balanced manner, and each with a number of suction points 24 required for secure gripping.

Preferably, as a function of the gripping object data set, a gripping sequence is also determined in which the gripping objects 12 are to be gripped.

The gripping objects 12 are then gripped one after the other. For this purpose, at least one suction point 24 assigned to a gripping object 12 is first activated (in the example: lifting piston 32 is transferred from the passive configuration to the active configuration) and then the gripping object 12 is suctioned with this at least one suction point 24. This is visualized in block 102 of FIG. 3 for the middle gripping object 12.

Preferably, the gripping object 12 is first lifted (see block 104 in FIG. 3) and then the other gripping objects 12 are gripped one after the other in an analogous manner (activating the assigned suction points 24, moving towards and suctioning the gripping object 12).

Once all gripping objects 12 have been suctioned onto the vacuum gripper 18 (see block 106 in FIG. 3), the vacuum gripper 18 with the gripping objects 12 held thereon is moved to the deposit area 16 and the gripping objects 12 are deposited there (see block 108 in FIG. 3).

As mentioned above, the handling system 10 may have different operating modes. To explain the operating modes, exemplary gripping configurations are explained below with reference to FIGS. 4 to 6.

FIG. 4 shows an exemplary gripping configuration in a high-performance operating mode of the handling system 10. Specifically, FIG. 4 shows the exemplary case in which a larger gripping object 12-1 covers a plurality of gripping objects 12-2, 12-3, 12-4 located underneath at least in sections, i.e. the gripping objects 12-1, 12-2, 12-3, 12-4 are held on the vacuum gripper 18 in an overlapping manner.

Suctioning the gripping objects 12-1, 12-2, 12-3, 12-4 can in particular be carried out in such a way that first the gripping objects 12-2, 12-3, 12-4 located below are suctioned one after the other (e.g. first gripping object 12-3, then gripping object 12-2 and then gripping object 12-4) and then the larger gripping object 12-1 is suctioned.

Preferably, when suctioning the lower gripping objects 12-2, 12-3, 12-4, a maximum acceleration of the manipulator 20 is limited in order to facilitate a secure holding of the (partially protruding) gripping objects 12-2, 12-3, 12-4. After suctioning the gripping object 12-1, which can serve as a support for the gripping objects 12-2, 12-3, 12-4 located underneath, the maximum acceleration can be increased.

FIG. 5 shows an exemplary gripping configuration in a safety operating mode, wherein the gripping objects 12 are arranged such that no object overlap occurs and edges 44 of the gripping objects 12 (in the example both the outer edges 46 and an inner edge 48 shown as an example) are arranged between the suction points 24. The inner edges 48 can, for example, be defined by a slot 50 in the gripping object 12.

FIG. 6 shows an exemplary gripping configuration in a suction cup protection operating mode, wherein the gripping objects 12 shown are arranged such that the outer edges 46 of the gripping objects 12 are not arranged on a suction point 24, but rather between or outside the vacuum gripper 18.

FIG. 7 shows an exemplary gripping configuration in a gripping object protection operating mode, wherein the gripping objects 12 are held at a specified safety distance 52 on the vacuum gripper 18.

The operating modes are not limited to the gripping configurations shown as examples.

1. A method for operating a handling system for transporting a plurality of gripping objects, in particular of different geometries, from a pick-up area to a deposit area, the handling system comprising:
a vacuum gripper having a plurality of individually activatable suction points;
a manipulator for moving the vacuum gripper;
a control device for controlling the handling system, comprising a data processing device and a non-volatile memory device, the method comprising:
receiving or determining a gripping object data set which represents the position in the pick-up area, weight and geometry for each gripping object,
determining, as a function of the gripping object data set, a gripping strategy data set,
which uniquely assigns at least one suction point of the plurality of suction points to each gripping object;
generating gripping control signals based on the gripping strategy data set, which cause the handling system to suction the gripping objects one after the other with the respectively assigned at least one suction point, so that the gripping objects are held together on the vacuum gripper;
generating manipulator control signals which cause the manipulator to move the vacuum gripper with the suctioned gripping objects to the deposit area.

2. The method according to claim 1, wherein determining the gripping strategy data set for each gripping object comprises:
determining, as a function of the weight of the gripping object, a minimum number n_{req} of suction points required for gripping the gripping object;
selecting, as a function of the geometry of the gripping object and in particular the geometry of at least a subset of the further gripping objects, an at least n_{req} corresponding number of suction points nₒᵤₜ of the plurality of suction points of the vacuum gripper.

3. The method according to claim 2, wherein selecting the suction points is carried out in such a way that
after suctioning, the gripping objects are held on the vacuum gripper in a torque-balanced manner;
and/or
after suctioning, at least a subset of the gripping objects, in particular all gripping objects, are held on the vacuum gripper without overlapping, in particular at a specified safety distance;
and/or
after gripping, at least a subset of the gripping objects are held in an overlapping manner on the vacuum gripper.

4. The method according to claim 2,wherein selecting the suction points further comprises: determining a position and/or orientation of the suction points on the gripping object, in particular as a function of the geometry of this gripping object and in particular of the geometry of at least a subset of the further gripping objects,
wherein the suction points are placed on the gripping object in the determined position and/or orientation.

5. The method according to claim 2, wherein the number n_{req} of required suction points is further determined under one or more of the following boundary conditions:
expected acceleration forces when handling the gripping objects;
material of the gripping object, in particular its porosity.

6. The method according to claim 2, wherein determining the gripping strategy data set, in particular selecting the suction points, is further determined as a function of the position of the gripping objects in the pick-up area.

7. The method according claim 6, wherein the gripping strategy data set also represents a gripping sequence in which the gripping objects are to be suctioned, wherein suctioning the gripping objects is carried out according to the gripping sequence, in particular wherein determining the gripping sequence is carried out as a function of a height position of the gripping objects in the pick-up area, wherein lower located gripping objects are suctioned earlier.

8. The method according to claim 7, wherein determining the gripping strategy data set is carried out in such a way that a second gripping object suctioned after a first gripping object at least partially covers the first gripping object.

9. The method according to claim 8, wherein the gripping control signals define a maximum acceleration of the manipulator after suctioning a respective gripping object, wherein the gripping control signals are determined such that the maximum acceleration after suctioning the second gripping object is greater than after suctioning the first gripping object.

10. The method according to claim 1, wherein the handling system has a high-performance operating mode, wherein in high performance operating mode:
determining the gripping strategy data set is carried out in such a way that a gripping object is only assigned the minimum number n_{req} of suction points required for gripping,
and/or
determining the gripping strategy data set, in particular selecting the suction points, is carried out in such a way that a second gripping object suctioned after a first gripping object at least partially covers the first gripping object, in particular wherein the gripping control signals define a maximum acceleration of the manipulator after suctioning a respective gripping object, wherein the gripping control signals are determined such that the maximum acceleration after suctioning the second gripping object is greater than after suctioning the first gripping object.

11. The method according to claim 10, wherein the handling system has a safety operating mode, wherein in the safety operating mode:
determining the gripping strategy data set is carried out in such a way, in particular the suction points are selected in such a way, that the gripping objects are held on the vacuum gripper without overlapping,
and/or
determining the gripping strategy data set further comprises: determining a position and/or orientation of the assigned at least one suction point on the gripping object as a function of the geometry of this gripping object such that edges of the gripping object are arranged between the suction points,
and/or
determining the gripping strategy data set is carried out in such a way that a gripping object is assigned more than the minimum number n_{req} of suction points required for gripping.

12. The method according to claim 11, wherein the manipulator control signals define a maximum acceleration of the manipulator hen moving the suctioned gripping objects from the pick-up area to the deposit area, wherein this maximum acceleration is greater in the high-performance operating mode than in the safety operating mode.

13. The method according to claim 2, wherein the handling system has a suction cup protection operating mode, wherein in the suction cup protection operating mode:
determining the grasping strategy data set further comprises: determining a position and/or orientation of the assigned suction points on the gripping object as a function of the geometry of this gripping object such that edges of the gripping object are arranged between the suction points,
and/or
determining the gripping strategy data set is carried out in such a way that a gripping object is only assigned the minimum number n_{req} of suction points required for gripping.

14. The method according claim 1, wherein the handling system has a gripping object protection operating mode, wherein in the gripping object protection operating mode determining the gripping strategy data set is carried out in such a way, in particular the suction points are selected in such a way, that two adjacent gripping objects are held at a specified safety distance on the vacuum gripper or at least do not overlap.

15. The method according to claim 14, further comprising, prior to determining the gripping strategy data set, selecting one of the operating modes.

16. The method according to claim 1, wherein suctioning gripping objects comprises:
activating the at least one suction point assigned to a first gripping object,
moving the vacuum gripper towards this gripping object;
suctioning this gripping object by means of the activated at least one suction point;
repeating steps a) to c) for the further gripping objects until all gripping objects are suctioned to the vacuum gripper.

17. The method according claim 1, wherein determining the gripping object data set comprises receiving image data representing an image of the gripping objects and analyzing said image data, in particular by means of methods of image processing.

18. The method according to claim 17, wherein determining the weight of a respective gripping object comprises:
determining a gripping object volume, comprising analyzing the image data by means of methods of workpiece segmentation,
determining a gripping object material, comprising analyzing the image data by means of a machine learning algorithm which is trained to determine a material of the gripping object from image data which represent an image of a gripping object.

19. A computer program product comprising commands that, when the program is executed by the data processing system, in particular by the data processing system of the control device of the handling system, cause the data processing system to carry out the method according to claim 1.

20. A handling system, comprising:
a vacuum gripper having a plurality of individually activatable suction points;
a manipulator for moving vacuum gripper; and
a control device for controlling the handling system, wherein the control device has a non-volatile memory device and a data processing system, wherein control instructions, in particular the computer program product according to the preceding claim, are stored on the non-volatile memory device, which cause the handling system to carry out the method according to claim 1.
